(19) United States
(12) Patent Application Publication
(10) Pub. No.: US 2025/0188627 A1
(43) Pub. Date: Jun. 12, 2025

(54) ELECTROLYSIS OR CO-ELECTROLYSIS REACTOR (SOEC) OR FUEL CELL (SOFC) WITH STACKING OF ELECTROCHEMICAL CELLS INCORPORATING MECHANICAL REINFORCEMENT ELEMENTS WITH TEMPERATURE-VARIABLE STIFFNESS

(71) Applicant: COMMISSARIAT A L'ENERGIE ATOMIQUE ET AUX ENERGIES ALTERNATIVES, Paris (FR)

(72) Inventors: Stephane DI IORIO, Grenoble (FR); Aurelien LECOQ, Grenoble (FR); Amelie MAISSE, Grenoble (FR); Karl VULLIEZ, Grenoble (FR)

(21) Appl. No.: 18/971,577

(22) Filed: Dec. 6, 2024

(30) Foreign Application Priority Data
Dec. 6, 2023 (FR) 2313691

(51) Int. Cl. C25B 9/60; C25B 1/04; C25B 1/22; C25B 9/73; H01M 8/0612; H01M 8/12

(52) U.S. Cl. CPC C25B 9/60; C25B 1/04; C25B 1/22; C25B 9/73; H01M 8/0631; H01M 8/12; H01M 2008/1293

(57) ABSTRACT

Electrolysis or co-electrolysis reactor (SOEC) or fuel cell (SOFC) with stacking of electrochemical cells incorporating mechanical reinforcement elements with temperature-variable stiffness. An electrochemical device formed by assembly, by alternate customary stacking, of electrochemical cells and of fluidic and electrical interconnects, in which at least one mechanical reinforcement element is installed at each stage to take up the flexural forces which are liable to occur in the stack during the initial thermomechanical treatment step.

### TECHNICAL FIELD

The present invention relates to the field of solid-oxide fuel cells (SOFC), the field of high-temperature electrolysis (HTE) of water or high-temperature steam electrolysis (HTSE) likewise with solid oxides (SOEC for Solid-Oxide Electrolyzer Cell), and the field of the high-temperature co-electrolysis of water and another gas, selected from carbon dioxide, CO₂, and nitrogen dioxide, NO₂.

The invention pertains more particularly to the realization of an electrochemical device constituting a reactor for high-temperature electrolysis (HTE) or co-electrolysis of water, of SOEC type, or of a fuel cell of SOFC type, with stacking of elementary electrochemical cells.

The invention is directed first and foremost to improving the assembly and the operation of such a device.

While the invention is described principally in reference to the application of high-temperature electrolysis of water, it is entirely applicable as well to co-electrolysis of water and another gas, selected from carbon dioxide (CO₂), as to an SOFC fuel cell.

The invention is applicable to an SOFC fuel cell which uses as its fuel alternatively hydrogen, a hydrocarbon, for example methane (CH₄), or any other fuel, such as NH₃.

### BACKGROUND

An SOFC fuel cell or an HTE electrolyzer is an electrochemical device consisting of a stack of elementary constituents that each include a solid-oxide electrochemical cell, consisting of three layers—anode/electrolyte/cathode—that are superposed on one another, and of interconnecting plates made of metal alloys, also called bipolar plates or interconnects. The function of the interconnects is both to let electrical current pass and gases circulate in the vicinity of each cell (injected steam and extracted hydrogen and oxygen in an HTE electrolyzer; injected air and hydrogen and extracted water in an SOFC cell) and to separate the anode and cathode compartments, which are the gas circulation compartments on the anode side and the cathode side of the cells, respectively.

To carry out high-temperature electrolysis (HTE) of steam, typically between 60° and 950° C., steam (H₂O) is injected into the cathode compartment. Under the effect of the current applied to the cell, water molecules in steam form dissociate at the interface between the hydrogen electrode (cathode) and the electrolyte: this dissociation produces dihydrogen gas (H₂) and oxygen ions. The dihydrogen is collected and exhausted at the outlet of the hydrogen compartment. The oxygen ions (O₂⁻) migrate through the electrolyte and recombine into dioxygen at the interface between the electrolyte and the oxygen electrode (anode).

To ensure operation of an SOFC fuel cell, air (oxygen) is injected into the cathode compartment, and hydrogen into the anode compartment. The hydrogen (H₂) will be converted into H⁺ ions and will release electrons, which are captured by the anode. The H⁺ ions arrive at the cathode, where they combine with the O₂⁻ ions, formed from the oxygen from the air, to make water. The transfer of the H⁺ ions and electrons to the cathode will produce a continuous electric current on the basis of the hydrogen.

To increase the flows of hydrogen and oxygen produced in the case of HTE electrolysis or to increase the electrical power supplied in the case of an SOFC fuel cell, it is known practice to stack multiple elementary electrochemical cells one atop another with separation by the interconnects. The assembly is positioned between two end connection plates which support the electrical supplies and the gas supplies/collection of an electrolyzer (electrolysis reactor) or of an SOFC fuel cell.

Furthermore, to improve the quality of the electrical contacts made between the interconnects and the electrodes, and hence the performance of the aforesaid electrochemical devices, electrical contact elements are interposed individually and arranged on the electrodes. In an electrochemical device, a nickel grid is conventionally used for contact with the hydrogen electrode (cathode in HTE reactor, anode in SOFC fuel cell), as it yields satisfactory results at low cost.

Throughout the preparation of an electrochemical device, each layer of the stack and each tier must be positioned very precisely and this position must be maintained.

Prior to operating an aforesaid electrochemical device, it is necessary to subject the stack thereof to at least one heat treatment step, referred to as reduction step, in order to place the electrochemical cells in their reduced form, rather than oxidized as they initially are.

This reduction step may be a thermomechanical cycle under gas—a reducing gas for the hydrogen electrode, and air or neutral gas for the oxygen electrode.

One particular heat treatment step was described in patent EP 2870650 B1.

The stacks employed to date generally use, in each of their stages, seals which must ensure the leaktightness between two different adjacent gas circulation compartments, i.e., an anode compartment and a cathode compartment. Advantageous seals were described in patent EP 3078071 B1. These seals have the particular feature of requiring thermal conditioning, during which they become compressed.

Contact elements, such as the layers described in patent application EP 2900846 A1 or nickel grids, also become compressed during the thermal conditioning and during the operation of the electrochemical device, which ensures their correct installation. The elements which serve as contact elements in the hydrogen chamber also become compressed. In other words, during the thermal conditioning step, a stack of an aforesaid electrochemical device becomes compressed, typically by several centimeters. At the present time, the compressing takes place correctly.

However, in certain SOEC/SOFC stacks, the inventors have observed harmful deformations during the heat treatment step prior to operation. These deformations reduce the contact zones between electrochemical cells and electrical contact elements.

This undesirable situation is shown in FIGS. 1 and 2, with an electrochemical device 1 comprising a stack of electrochemical cells 2 based on solid oxides, of SOEC/SOFC type, and electrical and fluidic interconnects 3 made of gastight and electronic-conducting material for supplying or collecting the electrical current to the cells and for supplying, collecting and circulating gases over each electrode of each electrochemical cell. Each electrochemical cell consists of a first electrode forming a cathode, a second electrode forming an anode, and an electrolyte interposed between the two electrodes.

For clarity, in these FIGS. 1 and 2, a single electrochemical cell 2 is shown as being arranged between two interconnects 3.

A first electrical contact element 4 is arranged in contact with an electrode of the cell 2 opposite an interconnect 3. This element may take the form of a nickel grid, preferably with cutouts as described in patent application FR 2213927 and possibly incorporating glass in the form of one or more beads to guide the gases, as described in patent EP 3156721 B1.

A second electrical contact element 5 is arranged in contact with another interconnect 3 opposite the other electrode of the cell 2. This element may be a conductive ceramic layer, especially a grooved layer; it may be a strip of strontium-doped lanthanum manganite (SLM) which has been cut out beforehand and which is bonded or hot-pressed directly onto the interconnect 3. Bonding may be carried out without residue, as described in patent application WO 2022/234214. The SLM strip may also be joined by hot pressing to a face of the interconnect 3, as described in EP 2900846 B1.

As shown at the end of the stack, an electrical contact element 5, especially an element identical to that in contact with an interconnect, may be secured to the inner face of an end plate 6 of the stack 1.

Seals 7, preferably made of glass-ceramic, are installed around the cell 2 and gas passages, being in contact with the cell 2 or one and the other of the electrical contact elements 4, 5. The seals 7 between two adjacent interconnects 3 within the stack may be supported by a leaktight frame 8 made of electrically insulating material, preferably of mica.

In this configuration, the metal elements (end plates 6, interconnects 3) lie initially on the seals 7, as shown in FIG. 1.

The stack 1 is tightened cold between a bearing point P and an axial load C, performed vertically. During the first temperature rise, the mechanical strength of the metal elements 6 and 3 decreases, while that of the seals 7 does not change before, typically, 650° C. or even 700° C., when these seals are made of glass-ceramic.

However, it may be the case that the flexural loading applied to the metal elements 3, 6 leads to irreversible deformation of said elements (FIG. 2), this being detrimental for the subsequent electrical contacts. The reason, as shown schematically, is that the planar faces of the metal elements are no longer in direct contact over their entire surface areas, although ideally they should be.

There is therefore a need to further improve electrochemical devices comprising a stack of electrochemical cells, forming an SOEC electrolysis reactor or an SOFC fuel cell, especially to prevent the consequences of unwanted irreversible deformation of electrical contact elements within the stack, which may occur in the transitory phase of first temperature rise during the thermal conditioning before the first operating cycle.

### SUMMARY OF THE INVENTION

For this purpose, a first subject of the invention is an electrochemical device constituting an SOEC electrolysis or co-electrolysis reactor or an SOFC fuel cell, intended to operate at high temperature, comprising:
a stack of electrochemical cells based on solid oxides, of SOEC/SOFC type, and of electrical and fluidic interconnects arranged individually on either side of each of the electrochemical cells, each interconnect comprising at least one component made of electron-conducting gastight material, for supplying or collecting the electrical current to the cells and for supplying, collecting and circulating gases over each electrode of each electrochemical cell;
two plates, called end plates, arranged at the ends of the stack;
a plurality of electrical contact elements, each arranged with contact with a face of one of the end plates or with an electrode of the electrochemical cells or with a face of an interconnect;
a plurality of seals, each arranged around each of the through-openings for ensuring sealing around each gas inlet/outlet within the stack;
a plurality of mechanical reinforcement elements, each arranged with contact with a face of one of the end plates or with an electrode of the electrochemical cells or with a face of an interconnect, the mechanical reinforcement elements being made of an electrically insulating material which exhibits a stiffness variable as a function of temperature and substantially equal to that of the seals, such that on a first rise in temperature of the device, before operation thereof, the reinforcement elements soften and then melt simultaneously with the seals, limiting the flexures of the end plates and the interconnects.

The mechanical reinforcement elements preferably comprise the same constituent material as the seals, preferably a glass-ceramic.

The mechanical reinforcement elements are advantageously in the form of beads, preferably closed on themselves, and/or of solid pads.

Further advantageously, at least a portion of the mechanical reinforcement elements are arranged at the center of the faces of the end plates or of the electrodes of the electrochemical cells or of the faces of the interconnects. When it is at the center of the constituents of the stack, the position at which force is taken up by the reinforcement elements enables a decrease in the flexural torque by a factor of 4, since this torque is dependent on the square of the length. A mechanical reinforcement element according to the invention may be a pointwise support at the center of the component, or any other geometric shape that decreases the flexural torque.

The material used for the wedge which takes up force is advantageously made of the same material as the seal, so that the change in stiffness takes place concomitantly when the softening/melting temperature is reached.

The surface area of a mechanical reinforcement element is preferably between 0.1 and 10 cm², more preferably being 0.5 cm².

According to a first advantageous variant embodiment, the electrical contact elements comprise at least one electrically conductive grid, preferably made of gold.

A grid made of gold may have a surface area of between 0.5 and 5 cm², preferably of the order of 2 cm² with a mesh count of 100 to 3600 meshes/cm². A nickel grid may also be contemplated. In that case, care will be taken to provide a sealing means around the grid to prevent oxidation of the grid. A copper grid may also be contemplated. A conductive ceramic grid may also be contemplated. Ferritic steel grids, preferably made of ferritic steel containing about 20% of chromium, preferably made of CROFER® or of K41 (441 steel), may operate if they are in grid form. The reason is that these high-Cr-content steels have good corrosion resistance and are good electrical conductors.

Grids made of precious metals, such as platinum, may also be contemplated.

The number of grids borne per face of the insert plate may be between 1 and 10 and is preferably 5. With a single grid, the amount of material is limited, but the mechanical equilibrium within a stack may not be optimal. With a number of 10 grids, mechanical equilibrium is ensured, but the amount of material used may be substantial.

The surface area of a grid is preferably between 0.5 and 5 cm², preferably of the order of 2 cm², for a sheet surface area of the order of 500 cm².

With further preference, the one or more grids are welded directly to a face of an interconnect and/or of an end plate. The welding may be spot wise.

According to one advantageous variant embodiment, a mechanical reinforcement element is in the form of a solid pad arranged in a cutout made at the center of the grid.

According to one advantageous embodiment, a number of five grids is provided in contact with one cell electrode, distributed squarely or rectangularly with one of them at the center of the square or rectangle.

According to this embodiment and an advantageous configuration, a mechanical reinforcement element is in the form of a bead closed on itself, surrounding the grid at the center of the square or rectangle.

According to a second advantageous variant embodiment, the electrical contact elements comprise at least one layer of a conductive ceramic material.

According to this second variant, the conductive ceramic material is advantageously selected from the group consisting of:
La_{0.6}Sr_{0.4}Co_{0.8}Fe_{0.2}O₃ (LSCF);
La_{0.8}Sr_{0.2}Cu_{0.9}Fe_{0.1}O_{2.5} (LSCuF);
La_{0.7}Sr_{0.3}CoO₃ (LSC);
Sm_{0.5}Sr_{0.5}CoO₃ (SSC);
SmBa_{0.5}Sr_{0.5}Co₂O₅ (SBSC);
GdSrCo₂O₅ (GSC);
La_{0.65}Sr_{0.3}MnO₃ (LSM);
LaBaCo₂O₅ (LBC);
YBaCo₂O₅ (YBC);
Nd_{1.8}Ce_{0.2}CuO₄ (NCC);
La_{0.8}Sr_{0.2}Co_{0.3}Mn_{0.1}Fe_{0.6}O₃ (LSCMF);
La_{0.98}Ni_{0.6}Fe_{0.4}O₃ (LNF);
La_{1.2}Sr_{0.8}NiO₄ (LSN);
La_{0.7}Sr_{0.3}FeO₃ (LSF);
La₂Ni_{0.6}Cu_{0.4}O₄ (LNC).

With further advantage, the conductive ceramic material is selected from the group consisting of LSM, LSC, LNF and LSCF.

The layer of conductive ceramic material is preferably hollowed out on at least a portion of its thickness. The hollowing may constitute grooves, holes or any other form. The hollowing-out and more particularly grooving of the contact layer makes it possible, for a given compression force, to increase the stress and hence to compress the layer more and thereby better correct the surface defects. Expressed alternatively, the grooving of the contact layer improves its capacity for compression. Conversely, a solid contact layer promotes electrical contact owing to a greater surface area for passage of the current.

Advantageously, the layer of conductive ceramic material is bonded, preferably by hot pressing or by means of a glue or by hot pressing by the sheet heated beforehand inductively or by Joule effect by passage of current. Reference may be made to the advantageous hot pressing methods described in patent EP 2900846 B1 or the residue-less bonding methods described in patent application WO 2022/234214. Inductive hot pressing itself entails heating the one or more interconnect sheets or end plate sheets, by Joule effect, then applying the layer of ceramic material directly at the desired location.

With further advantage, the thickness of the layer of conductive ceramic material on each face of the sheet is between 100 μm and 5 mm.

Care will also be taken to ensure that the surface area of a layer of ceramic material is minimized so as to increase the local tightening stresses applied to the stack. The reason is that the tightening force applied is constant. Therefore, reducing the surface area of the contact layer will increase the stress (F/S). For example, with a given force and with a layer of ceramic material whose surface area is two times smaller, the stress is two times greater.

Essentially, therefore, the invention comprises an electrochemical device formed by assembly, by customary alternate stacking, of electrochemical cells and of electrical and fluidic interconnects, in which at least one mechanical reinforcement element is installed at each stage to take up the flexural forces which are liable to occur in the stack during the initial thermomechanical treatment step.

The effect of this treatment is to complete at least the installation of the electrical contact elements and of the seals within the stack.

Moreover, in the stacks according to the prior art, the flexures appear during the phase of first temperature rise, owing to the softening of the seals.

By embedding mechanical reinforcements produced with materials having temperature-variable stiffness, said reinforcements are able to act by taking up the forces during the first temperature rise.

These reinforcements, advantageously made of the same material as the seals, more particularly of glass-ceramic, will remain stiff up to their softening/melting temperature, which is identical to that of the seals.

Once this temperature has been reached, all of the mechanical forces are transmitted uniformly to the electrical contact elements.

Ultimately, the invention exhibits numerous advantages, including the following:
the suppression of deformations in the SOEC/SOFC stacks, which may reduce the contact zones between electrical cells and electrical contact elements;
as a corollary, the acquisition of greater control of the level of electrical current crossing the SOEC/SOFC stacks;
simplicity and rapidity of implementing the mechanical reinforcement elements, which are embedded during the step of putting down the seals;
little additional cost, since it may be a case of simply adding beads and/or solid pads made of the same material as the seals.

Other advantages and features will emerge more clearly from a reading of the detailed description, which is given for illustration and not for limitation, with reference to the subsequent figures.

### BRIEF DESCRIPTION OF THE DRAWINGS

FIG. 1 is a schematic view in longitudinal section of a portion of an electrochemical device with stacking of solid oxide cells according to the prior art, after the step of stacking the various constituents has been performed.

FIG. 2 picks up on FIG. 1 and illustrates the flexural deformations which may occur during the first temperature rise in the initial thermomechanical treatment step applied to the device.

FIG. 3 is a schematic view in longitudinal section at an end plate forming a cover of an electrochemical device with stacking of solid oxide cells according to the prior art.

FIGS. 4A and 4B are schematic views in longitudinal section at an end plate forming a cover of an electrochemical device with stacking of solid oxide cells according to the invention, respectively before and after the concomitant installation of the seals and the mechanical reinforcement elements in accordance with the invention.

FIG. 5 is a photographic reproduction showing a sheet of mica bearing seals and a mechanical reinforcement element, installed on an end plate of an electrochemical device according to the invention.

FIG. 6 is a photographic reproduction of an insert according to the invention bearing electrical contact elements and a mechanical reinforcement element.

FIG. 7 is a schematic view in longitudinal section of a portion of another example of an electrochemical device with stacking of solid oxide cells according to the invention, after the step of stacking the various constituents has been performed.

### DETAILED DESCRIPTION

For clarity, the same elements of an electrochemical device according to the prior art and of an electrochemical device according to the invention are designated by the same reference numerals.

Throughout the present patent application, the terms “lower”, “upper”, “above”, “below”, “inner”, “outer”, “internal” and “external” are to be understood with reference to an electrochemical device according to the invention in operational configuration, i.e. with the modules being stacked vertically.

It is also pointed out that the electrolyzers or fuel cells described are of solid oxide type (SOEC, solid oxide electrolyzer cell, or SOFC, solid oxide fuel cell) operating at high temperature.

Thus, all the constituents (anode/electrolyte/cathode) of an electrolysis or fuel cell are ceramic.

The high operating temperature of an electrolyzer (electrolysis reactor) or of a cell is typically between 600° C. and 1000° C.

Typically, the characteristics of an SOEC electrolysis cell that is suitable for the invention, of the cathode-supported cell type (CSC), may be those indicated as follows in table 1 below.

TABLE 1

| Electrolysis cell | Unit | Value |
|---|---|---|
| Cathode | | |
| Constituent material | | Ni—YSZ |
| Thickness | μm | 400 |
| Thermal conductivity | W m⁻¹ K⁻¹ | 13.1 |
| Electrical conductivity | Q⁻¹ m⁻¹ | 10⁵ |
| Porosity | | 0.37 |
| Permeability | m² | 10⁻¹³ |
| Tortuosity | | 4 |
| Current density | A · m⁻² | 5300 |
| Anode | | |
| Constituent material | | LSM, LSC |
| Thickness | μm | between 10 and 50 |
| Thermal conductivity | W m⁻¹ K⁻¹ | 9.6 |
| Electrical conductivity | Ω⁻¹ m⁻¹ | 1 × 10⁴ |
| Porosity | | 0.37 |
| Permeability | m² | 10⁻¹³ |
| Tortuosity | | 4 |
| Current density | A · m⁻² | 2000 |
| Electrolyte | | |
| Constituent material | | YSZ |
| Thickness | μm | <10 |
| Resistivity | Ω m | 0.42 |

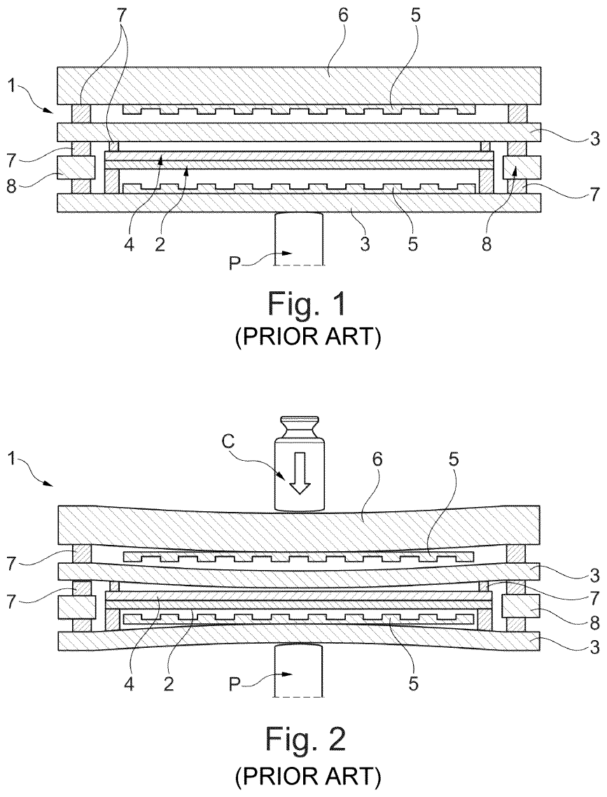

FIGS. 1 and 2, relating to a prior-art electrochemical device 1, were described in the introduction. They are therefore not addressed below.

Having noted the harmful deformations at the electrical contacts in a stack of an electrochemical device according to the prior art, the inventors resolved to embed mechanical reinforcement elements in this type of stack, with the role thereof being to take up the mechanical forces in order to minimize the flexural torques during the first temperature rise of the stack as required to perform installation of the seals.

To best follow the deformation of these seals, the inventors resolved to make these reinforcement elements of the same constituent material, typically of a sealing glass-ceramic.

The glass-ceramic of the reinforcement elements will therefore remain stiff up to its softening/melting temperature, after which all of the mechanical tightening forces will be transmitted to the electrical contact elements.

Accordingly, the reinforcement elements, which are made from the same material as the seals, act as force take-up wedges. The force is therefore taken up as soon as the flexural torque is present, and it lessens when the flexural torque reduces.

A first exemplary embodiment of the mechanical reinforcement elements is shown in connection with a plate 9 forming the cover of an electrochemical device with stacking of cells 2.

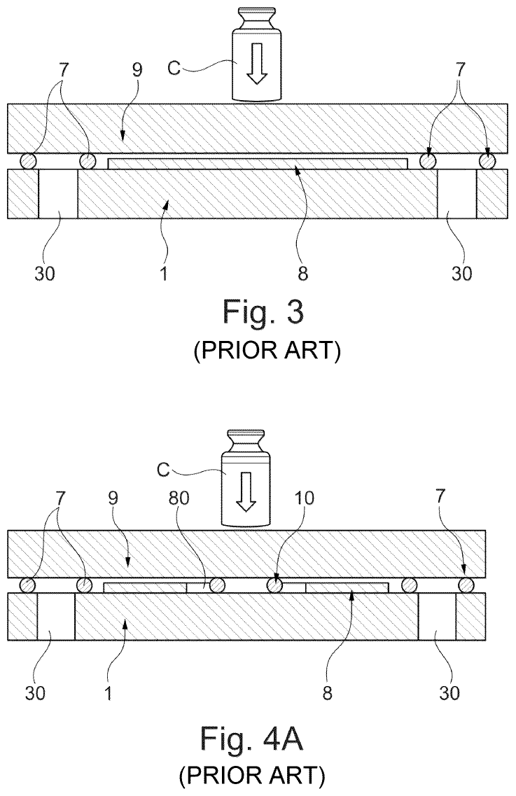

As shown in FIG. 3, a cover 9 of a device 1 according to the prior art, in other words without embedding of reinforcement elements for taking up force, bears against glass-ceramic seals 7 arranged at the periphery, which may also be supported by a support 8 generally in the form of a mica sheet.

Under a tightening load C, a cover 9 of this kind is therefore subject to flexural stresses which may result in its plastic deformation. This is because the seals 7 remain stiff to a high temperature, typically of around 650 to 700° C., before softening and then melting and becoming installed. The temperatures and the cycles required for the installation of the typically glass or glass-ceramic seals may vary according to the nature of the composition. The temperatures may typically be between 75° and 900° C. for a duration of 1 to 48 h in one or more cycles. The temperature rise for a device 1 may be up to 10° C./min.

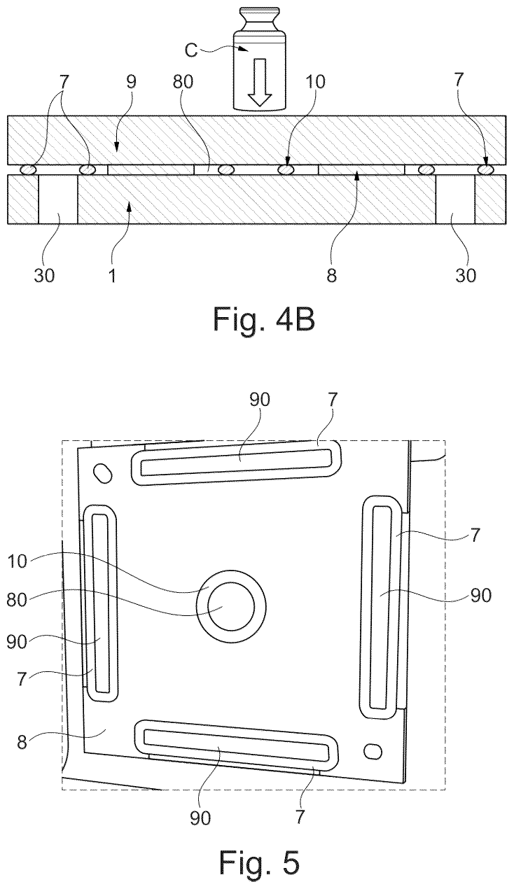

With a mechanical reinforcement element 10, in the form for example of a glass-ceramic washer at the center of the cover 6, preferably in a cutout 80 made in the support 8 of mica, as illustrated in FIG. 4A, the flexural stresses are drastically reduced with the melting of the glass-ceramic.

As shown in FIG. 4B, owing to the melting of the glass-ceramic both for the seals 7 and for the washer 10 forming a force take-up wedge, there is no further flexural stressing.

FIG. 5 shows a specific exemplary embodiment of a plate 9 forming a cover with a mica sheet 8 bearing not only the seals 7 at the periphery around cutouts 90 which are opposite gas passages, but also the force take-up washer 10 in a central cutout 80 in the sheet 8.

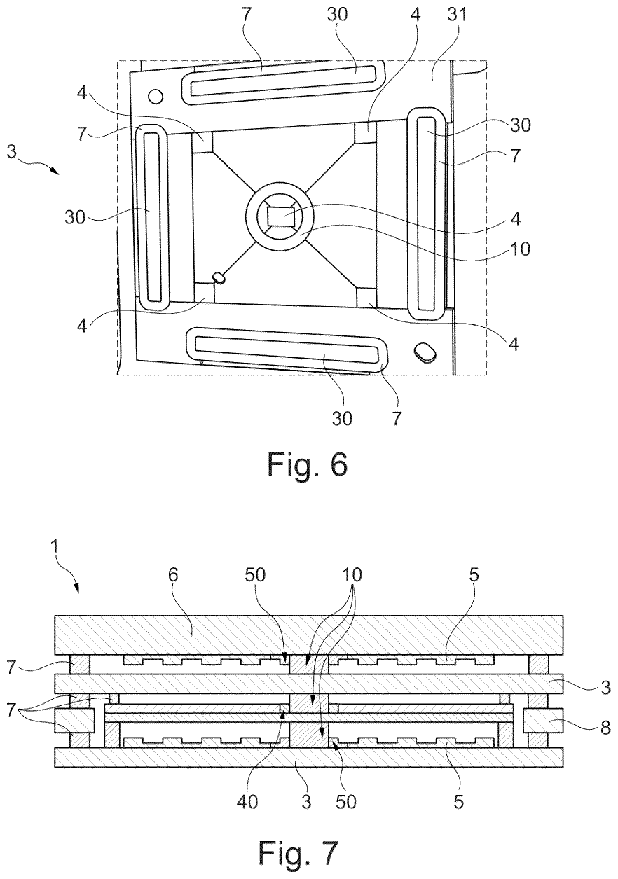

FIG. 6 shows another example of integration of a reinforcement element 10 for taking up force on a face of an interconnect 3.

As its electrical contact elements 4, the face of the interconnect 3 bears a number of five gold grids, distributed in a square with one at the center of the square. These grids 4 are preferably welded directly to the face of the outer sheet of the interconnect 3. Seals 7 have been put down in the form of beads around each through-opening 30 intended for the passage of the gases in a device 1.

A glass-ceramic bead 10, closed on itself to form a circular ring around the grid 4 in the center, forms a mechanical reinforcement element which will reduce the flexural torques that may affect the interconnect 3 during the first temperature rise.

FIG. 7 again shows another example of implementation of mechanical reinforcement elements 10, made of glass-ceramic.

As illustrated, a solid glass-ceramic pad 10 may be arranged at the center of each of the electrical contact layers 5, made particularly of LSM, in a cutout 50 made for this purpose.

Solid glass-ceramic pads 10 may also be installed in a cutout 40 of an electrical contact grid 4, made particularly of nickel.

This minimizes the flexural force at any point of an electrochemical device 1 with stacking of solid oxide cells.

Irrespective of its embedment within a device 1, care is taken to ensure that the surface area of a mechanical reinforcement element 10 is not too great, so as to avoid excessively reducing the active electrochemical surface areas of the cells 2. The surface area of a reinforcement element 10 is advantageously between 0.1 and 10 cm², and more preferably is 0.5 cm².

The invention is not limited to the examples that have just been described; characteristics of the illustrated examples may especially be combined together within variants not illustrated.

Other variants and improvements may be envisaged, without, however, departing from the scope of the invention.

A mechanical reinforcement element 10 made of glass-ceramic material according to the invention may be arranged preferably at the center between two constituents of the stack forming an electrochemical device.

The plate 9 forming the cover may be an end plate, arranged at the end of the top of a stack and having the primary function of stiffening, enabling supply of the current over a thick plate, enabling the forces to be taken up during return to cold. In this case, the end plate has no emergent opening, since it does not have the function of passing the gases into the stack.

In a stack in which the top end plate is required to have an emergent opening, as in patent application EP 3955353 A1, the cover is formed by an additional plate without an emergent opening.

1. An electrochemical device constituting an SOEC electrolysis or co-electrolysis reactor or an SOFC fuel cell, intended to operate at high temperature, comprising:
a stack of electrochemical cells based on solid oxides, of SOEC/SOFC type, and of electrical and fluidic interconnects arranged individually on either side of each of the electrochemical cells, each interconnect comprising at least one component made of electron-conducting gastight material, for supplying or collecting the electrical current to the cells and for supplying, collecting and circulating gases over each electrode of each electrochemical cell;
two plates, called end plates, arranged at the ends of the stack;
a plurality of electrical contact elements, each arranged with contact with a face of one of the end plates or with an electrode of the electrochemical cells or with a face of an interconnect;
a plurality of seals, each arranged around each of the through-openings for ensuring sealing around each gas inlet/outlet within the stack;
a plurality of mechanical reinforcement elements, each arranged with contact with a face of one of the end plates or with an electrode of the electrochemical cells or with a face of an interconnect, the mechanical reinforcement elements being made of an electrically insulating material which exhibits a stiffness variable as a function of temperature and substantially equal to that of the seals, such that on a first rise in temperature of the device, before operation thereof, the reinforcement elements soften and then melt simultaneously with the seals, limiting the flexures of the end plates and the interconnects.

2. The electrochemical device as claimed in claim 1, wherein the mechanical reinforcement elements comprising the same constituent material as the seals.

3. The electrochemical device as claimed in claim 1, wherein at least a portion of the mechanical reinforcement elements being arranged at the center of the faces of the end plates or of the electrodes of the electrochemical cells or of the faces of the interconnects.

4. The electrochemical device as claimed in claim 1, wherein the surface area of a mechanical reinforcement element being between 0.1 and 10 cm².

5. The electrochemical device as claimed in claim 1, wherein the mechanical reinforcement elements being in the form of beads.

6. The electrochemical device as claimed in claim 1, wherein the electrical contact elements comprising at least one electrically conductive grid.

7. The electrochemical device as claimed in claim 6, wherein the number of grids in contact with one cell electrode being between 1 and 10.

8. The electrochemical device as claimed in claim 6, wherein the surface area of a grid being between 0.5 and 5 cm².

9. The electrochemical device as claimed in claim 6, wherein the one or more grids being welded directly to a face of an interconnect and/or of an end plate.

10. The electrochemical device as claimed in claim 6, wherein a mechanical reinforcement element being in the form of a solid pad arranged in a cutout made at the center of the grid.

11. The electrochemical device as claimed in claim 6, further comprising a number of five grids in contact with one cell electrode, distributed squarely or rectangularly with one of them at the center of the square or rectangle.

12. The electrochemical device as claimed in claim 11, wherein a mechanical reinforcement element being in the form of a bead closed on itself, surrounding the grid at the center of the square or rectangle.

13. The electrochemical device as claimed in claim 1, wherein the electrical contact elements comprising at least one layer of a conductive ceramic material.

14. The electrochemical device as claimed in claim 13, wherein the conductive ceramic material being selected from the group consisting of:
La_{0.6}Sr_{0.4}Co_{0.8}Fe_{0.2}O₃ (LSCF);
La_{0.8}Sr_{0.2}Cu_{0.9}Fe_{0.1}O_{2.5} (LSCuF);
La_{0.7}Sr_{0.3}CoO₃ (LSC);
Sm_{0.5}Sr_{0.5}CoO₃ (SSC);
SmBa_{0.5}Sr_{0.5}Co₂O₅ (SBSC);
—GdSrCo₂O₅ (GSC);
La_{0.65}Sr_{0.3}MnO₃ (LSM);
—LaBaCo₂O₅ (LBC);
YBaCo₂O₅ (YBC);
Nd_{1.8}Ce_{0.2}CuO₄ (NCC);
La_{0.8}Sr_{0.2}Co_{0.3}Mn_{0.1}Fe_{0.6}O₃ (LSCMF);
La_{0.98}Ni_{0.6}Fe_{0.4}O₃ (LNF);
La_{1.2}Sr_{0.8}NiO₄ (LSN);
La_{0.7}Sr_{0.3}FeO₃ (LSF);
La₂Ni_{0.6}Cu_{0.4}O₄ (LNC).

15. The electrochemical device as claimed in claim 13, wherein the layer of conductive ceramic material being hollowed out on at least a portion of its thickness.

16. The electrochemical device as claimed in claim 13, wherein the layer of conductive ceramic material being bonded.

17. The electrochemical device as claimed in claim 13, wherein the thickness of the layer of conductive ceramic material being between 100 μm and 5 mm.

18. The electrochemical device as claimed in claim 13, wherein a mechanical reinforcement element being in the form of a solid pad arranged in a cutout made at the center of the ceramic layer.
